(19) United States
(12) Patent Application Publication
(10) Pub. No.: US 2020/0235616 A1
(43) Pub. Date: Jul. 23, 2020

(54) MOTOR-DRIVEN COMPRESSOR

(71) Applicant: KABUSHIKI KAISHA TOYOTA JIDOSHOKKI, Aichi-ken (JP)

(72) Inventors: Noriyuki SUZUKI, Kariya-shi (JP); Yoshiyuki NAKANE, Kariya-shi (JP)

(73) Assignee: KABUSHIKI KAISHA TOYOTA JIDOSHOKKI, Aichi-ken (JP)

(21) Appl. No.: 16/740,949

(22) Filed: Jan. 13, 2020

(30) Foreign Application Priority Data
Jan. 18, 2019 (JP) 2019-006885

(51) Int. Cl. H02K 1/16; H02K 3/38; H02K 9/00; F04D 1/04

(52) U.S. Cl. CPC H02K 1/165; F04D 1/04; H02K 9/005; H02K 3/38

(57) ABSTRACT

A motor-driven compressor includes an electric motor, a housing including a tubular bearing holder, and plastic members. Each of the plastic members includes a connecting passage. The electric motor includes a stator including a stator core and coils. The coils include a coil end. The connecting passage has opposite ends in the axial direction, each of the opposite ends including an opening so that two spaces defined by the stator core in the housing are connected to each other through the connecting passage. The bearing holder is at least partially opposed to one of the openings of the connecting passage and disposed at an inner side of the coil end in the radial direction.

### BACKGROUND

### 1. Field

The present disclosure relates to a motor-driven compressor.

### 2. Description of Related Art

A typical motor-driven compressor includes a compression portion, an electric motor that rotates a rotation shaft, and a housing that accommodates the electric motor. The compression portion uses rotation of the rotation shaft to compress fluid. The rotation shaft is rotationally supported by bearings in the housing. The housing includes tubular bearing holders that hold the bearings. The electric motor includes a tubular stator and a rotor located at a radially inner side of the stator. The stator includes a tubular stator core. The stator core includes teeth extending in the radial direction. Each of the teeth has a distal end including a flange. Slots are defined between adjacent ones of the teeth. The stator core includes opposite end surfaces in an axial direction of the rotation shaft and annular coil ends projecting beyond the respective end surfaces. The coil ends are portions of coils that are wound through the slots on the teeth.

To reduce the size of the motor-driven compressor in the axial direction of the rotation shaft, for example, the bearing holders may be at least partially disposed at a radially inner side of the coil ends. In this case, the coil ends have to be disposed maximally radially outward in a space of the stator core. Japanese Laid-Open Patent Publication No. 2005-184994 discloses an example of a motor-driven compressor including a slot insulation sheet configured to be inserted into a slot. The slot insulation sheet is disposed between a coil and a tooth so that the portion of the coil disposed in the slot is separated from the flange. This allows a coil end to be disposed at a radially outer position in the stator core.

### SUMMARY

Because the slot insulation sheet is not robust, during use, it is difficult to support the portion of the coil located in the slot when the portion of the coil is separated from the flange. Thus, it is difficult to maintain the coil end at a radially outer position in the stator core. This may hamper at least a portion of the bearing holder from being disposed at an inner side of the coil end in the radial direction. In addition, it is desired that coils and bearings are efficiently cooled.

It is an object of the present disclosure to provide a motor-driven compressor capable of effectively cooling a coil and a bearing and having a rotation shaft that is reduced in size in an axial direction.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One aspect of the present disclosure is a motor-driven compressor that includes a compression portion configured to use rotation of a rotation shaft to compress a fluid, an electric motor configured to rotate the rotation shaft, the electric motor including a tubular stator extending along an axis of the rotation shaft and a rotor disposed at an inner side of the stator in a radial direction, a housing accommodating the electric motor and including a tubular bearing holder that holds a bearing. The rotation shaft is rotationally supported by the bearing in the housing. The stator includes a tubular stator core and coils. The stator core includes teeth extending in the radial direction and slots defined between circumferentially adjacent ones of the teeth. The coils are wound through the slots on the teeth. The coils include a coil end projecting beyond at least one end surface of the stator core in a direction of the axis. The motor-driven compressor further comprises plastic members, each of the plastic members including a wall extending along the axis and a connecting passage surrounded by the wall and extending along the axis. Each of the teeth includes a proximal end, which is an outer end in the radial direction, and a distal end including a flange. The wall of each of the plastic members is disposed in a corresponding one of the slots between the coil and the flange. The connecting passage has opposite ends in the axial direction, each of the opposite ends including an opening so that two spaces defined by the stator core in the housing are connected to each other through the connecting passage. The bearing holder is at least partially opposed to one of the openings of the connecting passage and disposed at an inner side of the coil end in the radial direction.

Other features and aspects will be apparent from the following detailed description, the drawings, and the claims.

### BRIEF DESCRIPTION OF THE DRAWINGS

FIG. 1 is a sideward cross-sectional view showing an embodiment of a centrifugal compressor.

FIG. 2 is a cross-sectional view showing an electric motor included in the centrifugal compressor shown in FIG. 1.

FIG. 3 is an enlarged cross-sectional view showing a portion of a stator included in the electric motor shown in FIG. 2.

FIG. 4 is a perspective view showing a plastic member included in the centrifugal compressor shown in FIG. 1.

FIG. 5 is an enlarged cross-sectional view showing a portion of the stator shown in FIG. 3.

FIG. 6 is a partial perspective view showing the stator core of FIG. 3 to which the plastic member of FIG. 4 is coupled.

FIG. 7 is a schematic cross-sectional view showing windings wound on teeth.

FIG. 8 is a perspective view showing a plastic member in another embodiment.

FIG. 9 is a perspective view showing a plastic member in another embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

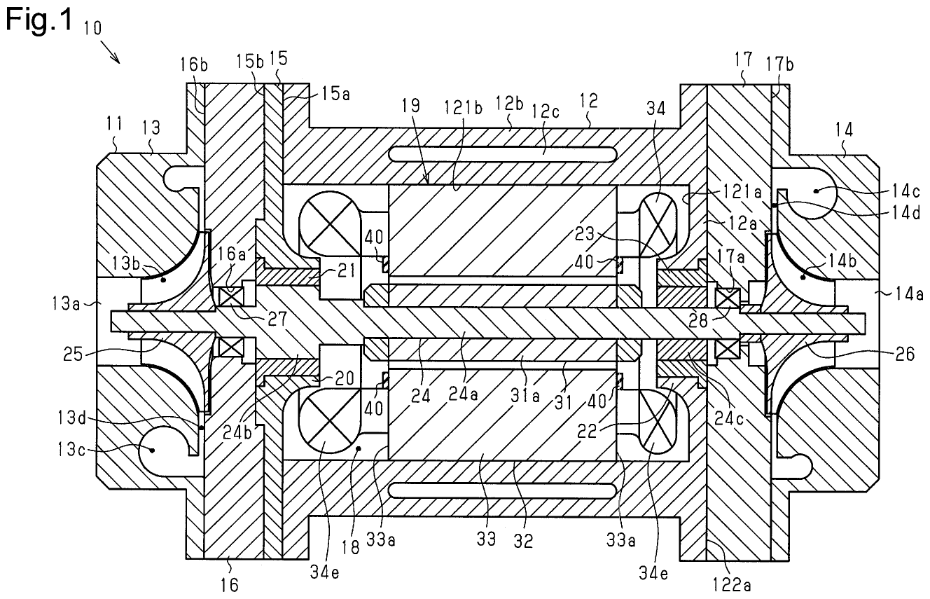

An embodiment of a centrifugal compressor, which is an example of a motor-driven compressor, will now be described with reference to FIGS. 1 to 7. The centrifugal compressor of the present embodiment is mounted on a fuel cell vehicle. The fuel cell vehicle includes a fuel cell system that supplies oxygen and hydrogen to generate electric power. The centrifugal compressor compresses air, that is, fluid containing oxygen, supplied to a fuel cell.

As shown in FIG. 1, a centrifugal compressor 10 includes a tubular housing 11. The housing 11 includes a motor housing member 12, a tubular first compressor housing member 13, a tubular second compressor housing member 14, a first plate 15, a second plate 16, and a third plate 17. The first compressor housing member 13, the second plate 16, the first plate 15, the motor housing member 12, the third plate 17, and the second compressor housing member 14 are arranged in order along the axis of the housing 11. The motor housing member 12 includes a planar end wall 12a (bottom wall) and a tubular circumferential wall 12b extending from an outer circumferential portion of the end wall 12a. The first plate 15 is coupled to an open end of the circumferential wall 12b of the motor housing member 12. That is, the first plate 15 closes the opening of the circumferential wall 12b of the motor housing member 12. The first plate 15 includes an end surface 15a that is in contact with the motor housing member 12 and an end surface 15b that is opposite to the end surface 15a.

An inner surface 121a of the end wall 12a, an inner circumferential surface 121b of the circumferential wall 12b, and the end surface 15a of the first plate 15 define a motor chamber 18. The motor chamber 18 accommodates an electric motor 19. As described above, the housing 11 accommodates the electric motor 19. The circumferential wall 12b of the motor housing member 12 includes a coolant jacket 12c through which coolant flows. The coolant jacket 12c extends along the entire circumference of the circumferential wall 12b. The coolant flowing through the coolant jacket 12c cools the electric motor 19.

The first plate 15 includes a tubular first bearing holder 20 projecting from a central portion of the end surface 15a of the first plate 15 toward the electric motor 19 and a first through hole extending through the first bearing holder 20. The first through hole is continuous with the inner circumferential surface of the first bearing holder 20. The first bearing holder 20 holds a tubular first air bearing 21 disposed to extend through the first through hole. The first through hole in the first bearing holder 20 extends through the first plate 15 and includes an open end that is in contact with the end surface 15b of the first plate 15.

The end wall 12a of the motor housing member 12 includes an outer surface 122a that is in contact with the third plate 17 and the inner surface 121a opposite to the outer surface 122a. The motor housing member 12 includes a tubular second bearing holder 22 projecting from a central portion of the inner surface 121a toward the electric motor 19 and a second through hole extending through the end wall 12a. The second through hole is continuous with the second bearing holder 22. The second bearing holder 22 holds a tubular second air bearing 23 disposed to extend through the second through hole. The second through hole in the second bearing holder 22 extends through the end wall 12a of the motor housing member 12 and includes an open end that is in contact with the outer surface 122a of the end wall 12a. The axis of the first bearing holder 20 is aligned with the axis of the second bearing holder 22.

The second plate 16 is coupled to the end surface 15b of the first plate 15. The second plate 16 includes a shaft insertion hole 16a extending through a central portion of the second plate 16 and an end surface 16b that is in contact with the first compressor housing member 13. The shaft insertion hole 16a is connected through the first through hole to a space defined by the inner circumferential surface of the first bearing holder 20. The axis of the shaft insertion hole 16a is aligned with the axis of the first bearing holder 20.

The third plate 17 is coupled to the outer surface 122a of the end wall 12a. The third plate 17 includes a shaft insertion hole 17a extending through a central portion of the third plate 17 and an end surface 17b that is in contact with the second compressor housing member 14. The shaft insertion hole 17a is connected through the second through hole to a space defined by the inner circumferential surface of the second bearing holder 22. The axis of the shaft insertion hole 17a is aligned with the axis of the second bearing holder 22.

The first compressor housing member 13 includes a first suction port 13a, which is a circular hole into which air is drawn. The first compressor housing member 13 is coupled to the end surface 16b of the second plate 16. The axis of the first suction port 13a is aligned with the axis of the shaft insertion hole 16a of the second plate 16 and the axis of the first bearing holder 20. The first suction port 13a is open in the outer surface of the first compressor housing member 13, more specifically, the end surface of the first compressor housing member 13 opposite to the second plate 16. A first impeller chamber 13b connected to the first suction port 13a, a first discharge chamber 13c, and a first diffuser flow passage 13d are defined between the first compressor housing member 13 and the end surface 16b of the second plate 16. The first discharge chamber 13c extends about the axis of the first suction port 13a to surround the periphery of the first impeller chamber 13b. The first impeller chamber 13b is connected to the first discharge chamber 13c through the first diffuser flow passage 13d. The first impeller chamber 13b is connected to the shaft insertion hole 16a of the second plate 16.

The second compressor housing member 14 includes a second suction port 14a, which is a circular hole into which air is drawn. The second compressor housing member 14 is coupled to the end surface 17b of the third plate 17. The axis of the second suction port 14a is aligned with the axis of the shaft insertion hole 17a and the axis of the second bearing holder 22. The second suction port 14a is open in the outer surface of the second compressor housing member 14, more specifically, the end surface of the second compressor housing member 14 opposite to the third plate 17. A second impeller chamber 14b connected to the second suction port 14a, a second discharge chamber 14c, and a second diffuser flow passage 14d are defined between the second compressor housing member 14 and the end surface 17b of the third plate 17. The second discharge chamber 14c extends about the axis of the second suction port 14a to surround the periphery of the second impeller chamber 14b. The second impeller chamber 14b is connected to the second discharge chamber 14c through the second diffuser flow passage 14d. The second impeller chamber 14b is connected to the shaft insertion hole 17a.

The housing 11 accommodates a rotation shaft 24. The first impeller chamber 13b accommodates a first impeller 25. The second impeller chamber 14b accommodates a second impeller 26. The rotation shaft 24 includes a first end coupled to the first impeller 25 and a second end coupled to the second impeller 26.

The rotation shaft 24 includes a rotation shaft body 24a, a first support 24b, and a second support 24c. The first support 24b is a portion radially projecting from the outer circumferential surface of the rotation shaft body 24a and is disposed in the first through hole of the first plate 15 at a radially inner side of the first air bearing 21. The second support 24c is disposed in the second through hole of the end wall 12a at a radially inner side of the second air bearing 23. The first support 24b is formed integrally with the rotation shaft body 24a. The second support 24c is formed separately from the rotation shaft body 24a and is press-fitted onto the outer circumferential surface of the rotation shaft body 24a.

A first seal member 27 is disposed between the rotation shaft 24 and the wall surface of the second plate 16 defining the shaft insertion hole 16a to limit leakage of air moving from the first impeller chamber 13b toward the motor chamber 18. Also, a second seal member 28 is disposed between the rotation shaft 24 and the wall surface of the third plate 17 defining the shaft insertion hole 17a to limit leakage of air moving from the second impeller chamber 14b toward the motor chamber 18. The first seal member 27 and the second seal member 28 are, for example, mechanical seals.

The electric motor 19 includes a tubular rotor 31 fixed to the rotation shaft 24 and a tubular stator 32 fixed to the housing 11. The rotor 31 is disposed at a radially inner side of the stator 32 and rotates integrally with the rotation shaft 24. The rotor 31 includes a tubular rotor core 31a fixed to the rotation shaft 24 and multiple permanent magnets arranged on the rotor core 31a. The stator 32 surrounds the outer circumference of the rotor 31. The stator 32 includes a tubular stator core 33 fixed to the inner circumferential surface 121b and coils 34 wound on the stator core 33. The stator core 33 has opposite ends in the axial direction of the rotation shaft 24, and each end includes an end surface 33a. The coils 34 project beyond the opposite end surfaces 33a of the stator core 33 in opposite directions along the axis. The portions of the coils 34 projecting beyond each end surface 33a of the stator core 33 form a coil end 34e that has an overall annular shape. When current flows to the coils 34 from a battery (not shown), the rotation shaft 24 rotates integrally with the rotor 31. As described above, the electric motor 19 rotates the rotation shaft 24.

When the rotation shaft 24 rotates integrally with the rotor 31, the first impeller 25 and the second impeller 26 rotate integrally with the rotation shaft 24. As a result, air is drawn from the first suction port 13a and compressed by the first impeller 25 in the first impeller chamber 13b. The compressed air flows through the first diffuser flow passage 13d and is discharged from the first discharge chamber 13c. The air discharged from the first discharge chamber 13c is drawn into the second suction port 14a through a pipe (not shown). The drawn air is again compressed by the second impeller 26 in the second impeller chamber 14b. The compressed air flows through the second diffuser flow passage 14d and is discharged from the second discharge chamber 14c. The air discharged from the second discharge chamber 14c is supplied to the fuel cell through a pipe (not shown). Thus, the first impeller 25 and the second impeller 26 configure a compression portion that uses rotation of the rotation shaft 24 to compress air.

Until the rotation speed of the electric motor 19 (rotation shaft 24) reaches a predetermined value, the first air bearing 21 is in contact with the first support 24b and supports the rotation shaft 24. Until the rotation speed of the electric motor 19 reaches the predetermined value, the second air bearing 23 is in contact with the second support 24c and supports the rotation shaft 24. When the rotation speed of the electric motor 19 reaches the predetermined value, the first support 24b is separated from the first air bearing 21 by dynamic pressure that is generated between the first support 24b and the first air bearing 21. At this time, the first air bearing 21 is not in contact with the first support 24b and supports the rotation shaft 24. Also, when the rotation speed of the electric motor 19 reaches the predetermined value, the second support 24c is separated from the second air bearing 23 by dynamic pressure that is generated between the second support 24c and the second air bearing 23. At this time, the second air bearing 23 is not in contact with the second support 24c and supports the rotation shaft 24. Thus, the rotation shaft 24 is rotationally supported by the first air bearing 21 and the second air bearing 23 in the housing 11.

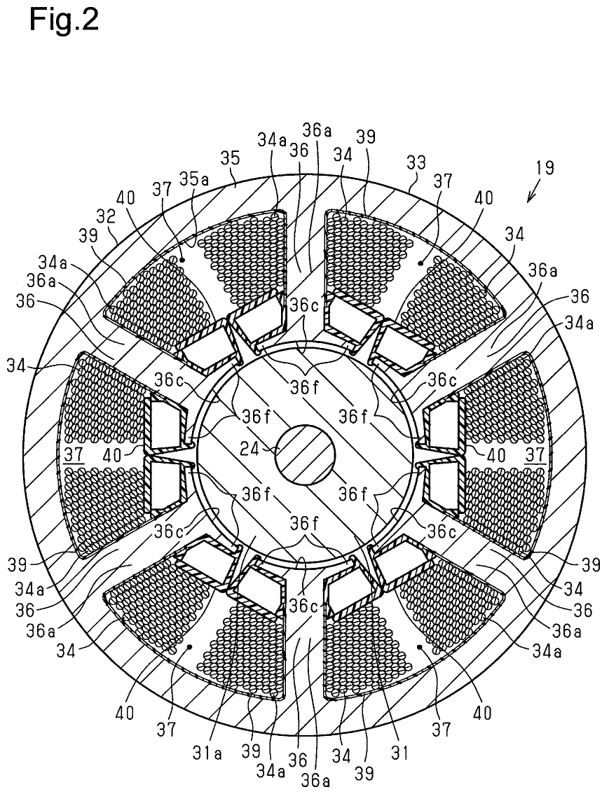

As shown in FIG. 2, the stator core 33 includes a tubular yoke 35 and multiple teeth 36. The teeth 36 extend from an inner circumferential surface 35a of the yoke 35 toward a radially inner side of the yoke 35. The teeth 36 are arranged at intervals in the circumferential direction of the yoke 35. In the description hereafter, “the circumferential direction” refers to the circumferential direction of the yoke 35, and “the radial direction” refers to the radial direction of the yoke 35. Each of the teeth 36 includes a tooth extension 36a extending from the inner circumferential surface 35a of the yoke 35 toward the axis of the stator core 33 and two flanges 36f. The two flanges 36f extend from the distal end of the tooth extension 36a, that is, the end of the tooth extension 36a opposite to the inner circumferential surface 35a of the yoke 35, in circumferentially opposite directions. In other words, the radially inner end, or the distal end, of each of the teeth 36 includes a pair of flanges 36f extending in opposite directions. The distal end, that is, the end opposite to the yoke 35, of each of the teeth 36 includes a surface 36c. The surface 36c extends from the distal surface of the tooth extension 36a, that is, the surface of the tooth extension 36a opposite to the yoke 35, to the distal end of each flange 36f. Each surface 36c is a curved surface that is arcuate along the outer circumferential surface of the rotor core 31a. The portions of the two flanges 36f configuring the curved surface is an opposing surface that is opposed to the rotor 31.

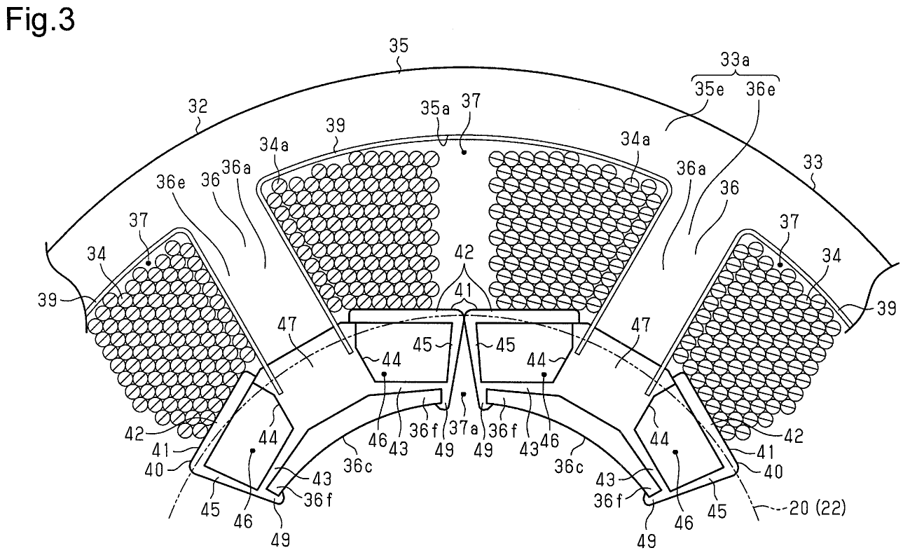

Referring to FIG. 3, the yoke 35 includes opposite ends in the axial direction of the stator core 33, and each end includes a flat end surface 35e. Each of the teeth 36 includes opposite ends in the axial direction of the stator core 33, and each end includes a flat end surface 36e. The length of the yoke 35 along the axis of the stator core 33 is the same as the length of the multiple teeth 36 along the axis of the stator core 33. On each axial end of the stator core 33, the end surface 35e of the yoke 35 is coplanar with the end surfaces 36e of the teeth 36. The plane is the end surface 33a of the stator core 33.

The stator core 33 includes multiple slots 37. Each slot 37 is defined between two of the teeth 36 that are adjacent to each other in the circumferential direction. The coils 34 are formed by winding windings 34a through the slots 37 on the teeth 36 by way of concentrated winding. In other words, the coils 34 are partially located in the slots 37.

The stator 32 includes multiple slot insulation sheets 39. Each slot insulation sheet 39 is disposed in the corresponding one of the slots 37 between the coil 34 and the stator core 33. The slot insulation sheet 39 insulates the coil 34 from the stator core 33 in the slot 37. The slot insulation sheet 39 is an elongated sheet that is curved in the shape of U in a transverse direction, which is orthogonal to a longitudinal direction of the slot insulation sheet 39. The longitudinal direction of the slot insulation sheet 39 conforms to the axial direction of the stator core 33. The slot insulation sheet 39 extends along the yoke 35 and the teeth 36, which define the slot 37. The slot insulation sheets 39 extend from a first end to a second end of the stator core 33 in the axial direction. The slot insulation sheet 39 has longitudinal opposite edges projecting beyond the respective end surfaces 33a of the stator core 33.

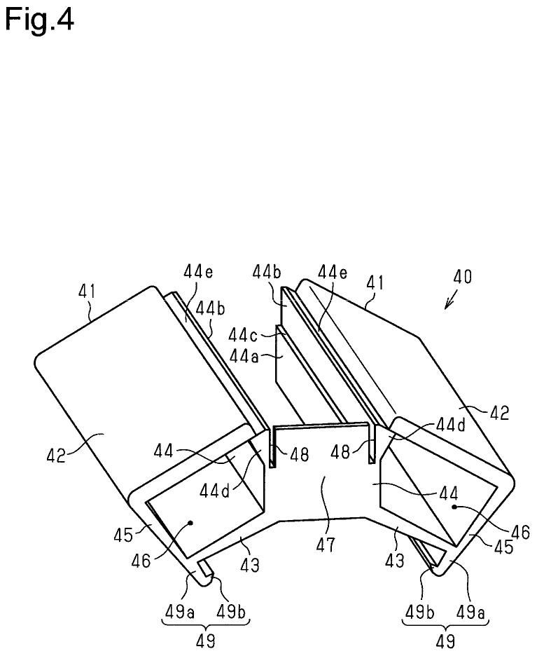

As shown in FIGS. 3 and 4, the centrifugal compressor 10 includes multiple plastic members 40. Each plastic member 40 includes two walls 41 extending in the axial direction of the rotation shaft 24 and a contact portion 47 connecting the two walls 41. The two walls 41 are respectively inserted into two of the slots 37 that are adjacent to each other in the circumferential direction. Each wall 41 is disposed in the corresponding slot 37 between the coil 34 and the flange 36f. More specifically, the coil 34 is spaced apart from the flange 36f by the wall 41.

Each wall 41 includes a coil contact wall 42, a flange contact wall 43, and first support wall 44, and a second support wall 45. The coil contact wall 42 is in contact with the coil 34 and supports the coil 34. The flange contact wall 43 is in contact with the flange 36f. The first and second support walls 44 and 45 support the coil contact wall 42. The coil contact wall 42, the flange contact wall 43, the first support wall 44, and the second support wall 45 are each an elongated thin plate.

The longitudinal directions of the coil contact wall 42, the flange contact wall 43, the first support wall 44, and the second support wall 45 conform to each other. The coil contact wall 42, the flange contact wall 43, the first support wall 44, and the second support wall 45 have the same length in the longitudinal direction. The length of the coil contact wall 42, the flange contact wall 43, the first support wall 44, and the second support wall 45 in the longitudinal direction is approximately one half of the length of the stator core 33 in the axial direction. The transverse direction of the coil contact wall 42 conforms to the transverse direction of the flange contact wall 43. The coil contact wall 42 extends parallel to the flange contact wall 43.

The flange contact wall 43 extends along the surface of the flange 36f faced toward the yoke 35. The flange contact wall 43 has a first edge and a second edge in the transverse direction. The first and second support walls 44 and 45 respectively extend from the first edge and the second edge of the flange contact wall 43 toward the coil contact wall 42. The first support wall 44 extends along a side surface of the tooth extension 36a. The side surface of the tooth extension 36a is a surface defining the slot 37. As the second support wall 45 extends away from the flange contact wall 43, the second support wall 45 is separated from the first support wall 44. The first support wall 44 is disposed closer to the corresponding one of the teeth 36 than the second support wall 45.

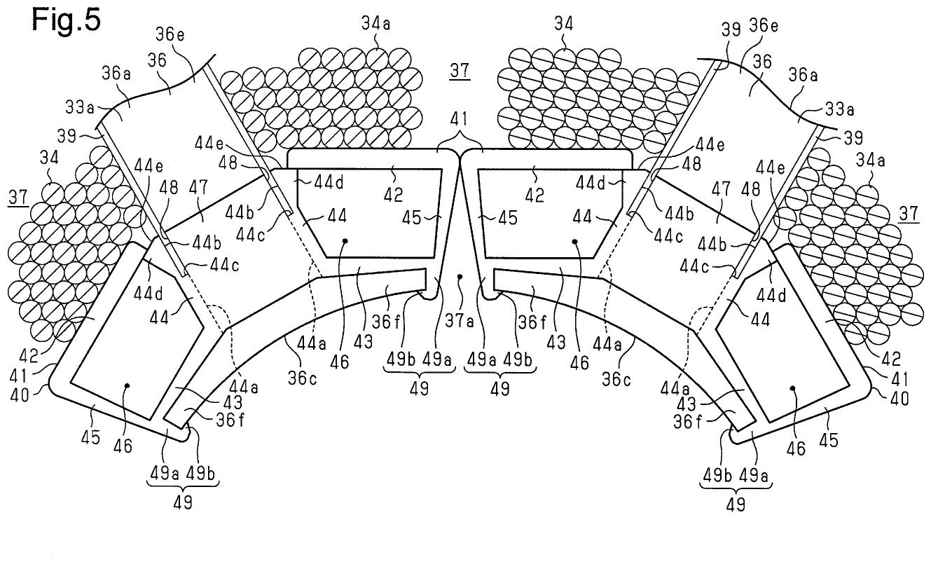

As shown in FIGS. 4 and 5, the first support wall 44 has a surface faced toward the tooth extension 36a and including a contact surface 44a and a separate surface 44b. The contact surface 44a is continuous with the flange contact wall 43 and is in contact with the side surface of the tooth extension 36a. The separate surface 44b is located on an end of the first support wall 44 opposite to the flange contact wall 43 and is separate from the side surface of the tooth extension 36a. The contact surface 44a and the separate surface 44b are connected by a step surface 44c. The step surface 44c extends in a direction intersecting the direction in which the tooth extension 36a extends.

The first support wall 44 has an end opposite to the flange contact wall 43 including a thick portion 44d. The thickness of the thick portion 44d is gradually increased at positions away from the flange contact wall 43. The thick portion 44d has a flat end surface 44e opposite to the flange contact wall 43. The end surface 44e extends in the transverse direction of the coil contact wall 42. The separate surface 44b is a surface of the thick portion 44d faced toward the tooth extension 36a.

The coil contact wall 42 extends from the distal end of the second support wall 45, that is, the end of the second support wall 45 opposite to the flange contact wall 43, toward the distal end of the first support wall 44, that is, the end of the first support wall 44 opposite to the flange contact wall 43. The coil contact wall 42 is continuous with the second support wall 45. The coil contact wall 42 has a first end that is opposite to the second support wall 45. The first end of the coil contact wall 42 is in contact with the end surface 44e of the thick portion 44d. Thus, the first support wall 44 is not continuous with the coil contact wall 42. The first support wall 44 is separate from the coil contact wall 42. Each wall 41 includes a connecting passage 46 defined by the coil contact wall 42, the flange contact wall 43, the first support wall 44, and the second support wall 45. The connecting passage 46 extends along the axis of the stator core 33 and surrounded by the wall 41. The connecting passage 46 has opposite end openings in the axial direction of the rotation shaft 24. The stator core 33 defines two spaces in the motor housing member 12. The two spaces are connected to each other through the connecting passages 46.

Each plastic member 40 includes the contact portion 47. The contact portion 47 is a thin flat plate that is in contact with an end surface 33a of the stator core 33. The region of the end surface 36e that is in contact with the contact portion 47 is located in the vicinity of the distal end of the tooth 36, that is, the end of the tooth 36 opposite to the yoke 35. The two walls 41 of each plastic member 40 are respectively inserted into the two circumferentially adjacent slots 37. The contact portion 47 extends over the corresponding tooth 36 and connects the two walls 41 (first wall 41 and second wall 41). In other words, the first wall 41 and the second wall 41, which are inserted into adjacent ones of the slots 37 located at opposite sides of the tooth 36, are connected to each other by the contact portion 47. The two walls 41 each have a first edge of the first support wall 44 in the longitudinal direction. The contact portion 47 connects the first edges to each other.

The contact portion 47 includes circumferentially opposite ends that are respectively continuous with first edges of the two contact surfaces 44a of the plastic member 40 in the longitudinal direction. In other words, the contact portion 47 connects the longitudinal first edges of the two contact surfaces 44a to each other. Each of the plastic members 40 includes two sheet recesses 48. Each sheet discharge recess 48 is a cutaway portion formed between the contact portion 47 and a longitudinal first edge of the corresponding one of the separate surfaces 44b.

The slot insulation sheet 39 has opposite ends in the transverse direction, and each end is located between the separate surface 44b and the side surface of the tooth extension 36a. In other words, the slot insulation sheet 39 is partially located between the first support wall 44 and the tooth 36. The opposite ends of the slot insulation sheet 39 in the transverse direction each include a portion projecting beyond the end surface 33a in the axial direction (longitudinal direction of slot insulation sheet 39). The projected portions are inserted into the sheet recesses 48.

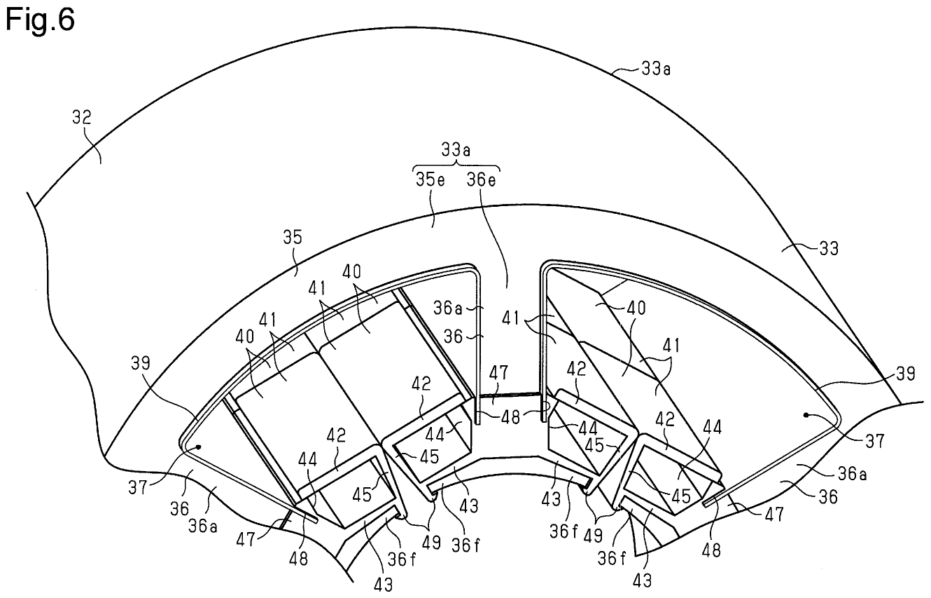

As shown in FIG. 6, when the plastic members 40 are coupled to the stator core 33, each contact portion 47 is in contact with the corresponding one of the end surfaces 36e, and the two walls 41 are inserted into the two circumferentially adjacent slots 37. The plastic members 40 are disposed on the stator core 33 so that the plastic members 40 are arranged next to one another in the circumferential direction.

In each slot 37, the two coil contact walls 42, which are adjacent to each other in the circumferential direction, have ends that are connected to the respective second support walls 45 and in contact with each other. In other words, in each slot 37, the circumferentially adjacent walls 41 have circumferential ends that are in contact with each other. As described above, the two plastic members 40 are arranged to be adjacent to each other in the same slot 37. The plastic members 40 are configured to elastically deform so that when the walls 41 of the two plastic members 40 in a slot 37 are separated from each other, the slot 37 is open toward the rotor 31, and when the walls 41 of the two plastic members 40 are in contact with each other, the opening of the slot 37 toward the rotor 31 is closed. More specifically, movement of the walls 41 is realized by elastic deformation of the plastic members 40.

The centrifugal compressor 10 includes multiple first plastic members 40 inserted into the slots 37 from a first axial end and multiple second plastic members 40 inserted into the slots 37 from a second axial end. The contact portion 47 of the first plastic member 40 and the contact portion 47 of the second plastic member 40 are in contact with the respective end surfaces 36e of each tooth 36. When the two walls 41 are inserted into the same slot 37, the ends of the two walls 41 inserted toward each other abut on each other in the slot 37.

As shown in FIG. 5, each of the plastic members 40 includes two hooks 49. Each of the hooks 49 includes an extension 49a (upright portion) and a claw 49b extending from the extension 49a. The hooks 49 are, for example, hook-shaped protrusions. The extension 49a extends from the second edge of the flange contact wall 43 in the transverse direction in a direction away from the second support wall 45. The claw 49b extends toward the first support wall 44 from the distal end of the extension 49a, that is, the end of the extension 49a opposite to the flange contact wall 43. The length of the extension 49a along the axis is the same as the length of the claw 49b along the axis. The length of the extension 49a along the axis and the length of the claw 49b along the axis are the same as the length of the second support wall 45 along the axis. The length along the axis is the length of the second support wall 45 in the longitudinal direction.

The surface of the second support wall 45 opposite to the first support wall 44 is coplanar with the surface of the extension 49a opposite to the first support wall 44. The extension 49a is located in a slot opening 37a, that is, a gap between the circumferentially adjacent flanges 36f. The claw 49b engages the surface of the flange 36f opposite to the yoke 35. As described above, the hooks 49 of the plastic member 40 each include the extension 49a disposed in the slot opening 37a and the claw 49b engaging the opposing surface of the flange 36f. Each of the hooks 49 covers the distal corner of the corresponding one of the flanges 36f.

As shown in FIG. 3, in the slots 37, the coils 34 are separated from the flanges 36f by an amount corresponding to the walls 41 located between the coils 34 and the flanges 36f. Thus, the coil ends 34e are located at the maximally radially outer position. The first and second bearing holders 20 and 22 are disposed at a radially inner side of the two coil ends 34e, respectively. At this time, the first and second bearing holders 20 and 22 are at least partially opposed to the openings of the connecting passages 46.

The operation of the present embodiment will now be described.

The walls 41, which are disposed in the slots 37 between the coils 34 and the flanges 36f, each include the first and second support walls 44 and 45 supporting the coil contact wall 42. The first and second support walls 44 and 45 extend from the flange contact wall 43 toward the coil contact wall 42. The portions of the coils 34 located in the slots 37 are separated from the flanges 36f and stably supported by the walls 41. Since the first and second bearing holders 20 and 22 are located at a radially inner side of the respective coil ends 34e, the size of the centrifugal compressor 10 is reduced in the axial direction.

In addition, the contact portions 47 are in contact with the end surfaces 33a of the stator core 33. This restricts movement of the plastic members 40 relative to the stator core 33 along the axis of the rotation shaft 24. In addition, the hooks 49 engage the surfaces of the flanges 36f opposed to the rotor 31, and the flange contact walls 43 are in contact with the flanges 36f in the slots 37. This restricts movement of the plastic members 40 relative to the stator core 33 in the radial direction of the yoke 35.

Each of the walls 41 includes the connecting passage 46 extending along the axis of the rotation shaft 24. The connecting passage 46 has opposite end openings in the axial direction of the rotation shaft 24. The stator core 33 defines two spaces in the motor housing member 12. The two spaces are connected to each other through the connecting passages 46. Thus, for example, when air present in the motor chamber 18 flows through the connecting passages 46, the air cools the coils 34. In addition, each of the first bearing holder 20 and the second bearing holder 22 is at least partially opposed to the openings of the respective connecting passages 46. Thus, the air flowing out of the connecting passages 46 cools the first bearing holder 20 and the second bearing holder 22. As a result, the first air bearing 21 and the second air bearing 23 are cooled.

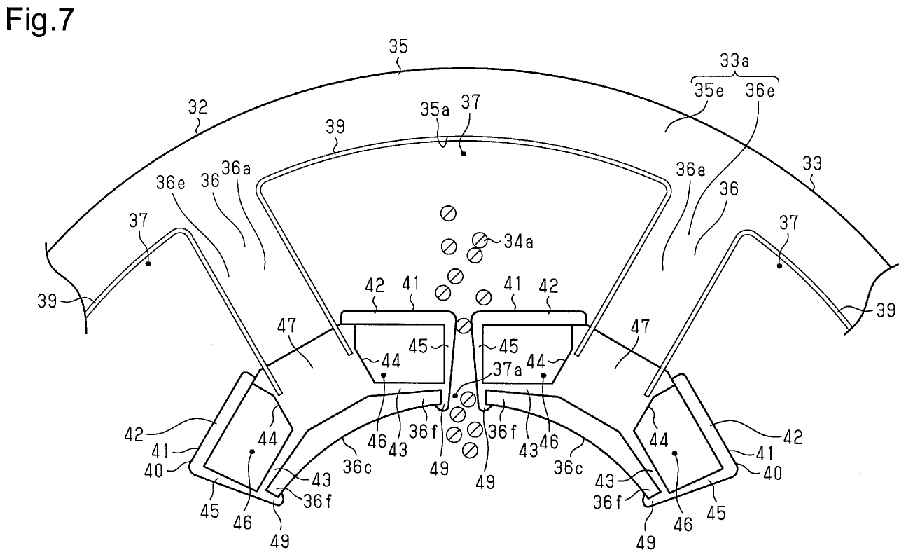

As shown in FIG. 7, when winding the winding 34a on the teeth 36, the winding 34a passes through the slot opening 37a and approaches the gap between the circumferentially adjacent walls 41 in the slot 37. The first support walls 44 are separate from the coil contact walls 42. In other words, the coil contact walls 42 are in contact with the end surfaces 44e of the first support walls 44 but are movable relative to the end surfaces 44e. Thus, when the plastic members 40 receive external force from the winding 34a, the first ends of the coil contact walls 42 are guided by the end surfaces 44e of the first support walls 44 and moved toward the respective teeth 36. At this time, the plastic members 40 elastically deform so that the distal ends of the second support walls 45 that are adjacent to each other in the same slot 37 move away from each other. The elastic deformation causes the slot 37 to open toward the rotor 31. This allows the winding 34a to pass through the gap between the walls 41 that are adjacent to each other in the same slot 37. At this time, the winding 34a is guided by the hooks 49 and guide surfaces of the second support walls 45. The guide surfaces are the surfaces of the second support walls 45 located in the slot 37 and opposite to the first support walls 44. After the winding 34a passes through the gap between the two walls 41, the plastic members 40 are restored to the shape before the deformation. More specifically, when the winding of the windings 34a on the teeth 36 is completed, the walls 41 that are adjacent to each other in each slot 37 again come into contact with each other. As a result, the opening of the slot 37 toward the rotor 31 is closed. This prevents the windings 34a from being ejected from the slot 37 through the slot opening 37a.

The above described embodiment achieves the following advantages.

(1) The centrifugal compressor 10 includes the plastic members 40 disposed between the coils 34 and the flanges 36f in the slots 37. The plastic members 40 extend along the axis of the rotation shaft 24. Each of the plastic members 40 includes the walls 41 configured to separate the coils 34 from the flanges 36f. The portions of the coils 34 located in the slots 37 are separated from the flanges 36f and stably supported by the walls 41. Thus, the coil ends 34e are maintained in a state located at a radially outer side of the flanges 36f in the slots 37. This allows the first bearing holder 20 and the second bearing holder 22 to be readily disposed at a radially inner side of the two coil ends 34e, respectively. Each of the plastic members 40 further includes the connecting passages 46 extending along the axis and surrounded by the walls 41. The connecting passages 46 each have opposite end openings in the axial direction of the rotation shaft 24. The connecting passages 46 connect the two spaces defined by the stator core 33 on both sides of the stator core 33 along the axis in the housing 11. Thus, the coils 34 are cooled by air flowing through the connecting passages 46. In addition, each of the first bearing holder 20 and the second bearing holder 22 is at least partially opposed to the openings of the connecting passages 46. Thus, the air flowing out of the connecting passages 46 cools the first bearing holder 20 and the second bearing holder 22. As a result, the first air bearing 21 and the second air bearing 23 are cooled. The configuration described above reduces the size of the rotation shaft 24 of the centrifugal compressor 10 in the axial direction and efficiently cools the coils 34, the first air bearing 21, and the second air bearing 23.

(2) The plastic members 40 include the contact portions 47. The contact portions 47 are in contact with the end surfaces 33a of the stator core 33. This restricts movement of the plastic members 40 relative to the stator core 33 along the axis.

(3) The contact portion 47 connects the first wall 41 and the second wall 41, which are inserted into adjacent ones of the slots 37 located at opposite sides of the tooth 36. With this configuration, the two walls 41 connected by the contact portion 47 are inserted into the circumferentially adjacent slots 37, so that the two walls 41 are respectively disposed in the two slots 37 that are adjacent to each other over the tooth 36. This simplifies the task of installing the walls 41 in the multiple slots 37.

(4) The plastic member 40 includes the hooks 49. The hooks 49 engage the surfaces of the flanges 36f opposed to the rotor 31. In addition, the flange contact walls 43 are in contact with the flanges 36f in the slot 37. This restricts movement of the plastic member 40 relative to the stator core 33 in the radial direction.

(5) Two of the plastic members 40 are adjacent to each other in the same slot 37. When the two walls 41 are separated from each other in the same slot 37, the slot 37 is open toward the rotor 31. Subsequently, when the walls 41 are in contact with each other, the opening of the slot 37 toward the rotor 31 is closed. Such movement of the walls 41 is realized by elastic deformation of the plastic members 40. When winding the winding 34a on the teeth 36, the winding 34a passes through the slot opening 37a and approaches the gap between the adjacent plastic members 40 in the slot 37. At this time, as the plastic members 40 elastically deform, the two walls 41 that are in contact with each other in the same slot 37 move away from each other. This allows the winding 34a to pass through the gap between the adjacent walls 41. When the winding of the windings 34a on the teeth 36 is completed, the plastic members 40 are restored to the shape before the deformation. More specifically, the walls 41 that are adjacent to each other in each slot 37 return to the contact state. This prevents the windings 34a from being ejected from the slot 37 toward the rotor 31.

(6) In the present embodiment, there is no need to, for example, increase the thickness of the flanges 36f in order to dispose the coil ends 34e at the maximally radially outer position in the yoke 35. This avoids a situation in which, for example, an effect on magnetic flux flowing in the stator core 33 causes the electric motor 19 to have a decreased rotation efficiency.

(7) The hooks 49 cover the distal corners of the flanges 36f Thus, when winding the winding 34a on the teeth 36, the winding 34a approaching the slot opening 37a may not come into contact with the corners of the flanges 36f.

(8) When winding the winding 34a on the teeth 36, the slot insulation sheet 39 may move radially outward in the yoke 35. Even in this case, the slot insulation sheet 39 is partially located between the first support wall 44 and the tooth 36. This limits exposure of the side surface of the tooth extension 36a in the slot 37. As a result, the reliability of insulation between the coils 34 and the teeth 36 is improved.

The above embodiment may be modified as described below. The above-described embodiment and the following modified examples can be combined as long as the combined modified examples remain technically consistent with each other.

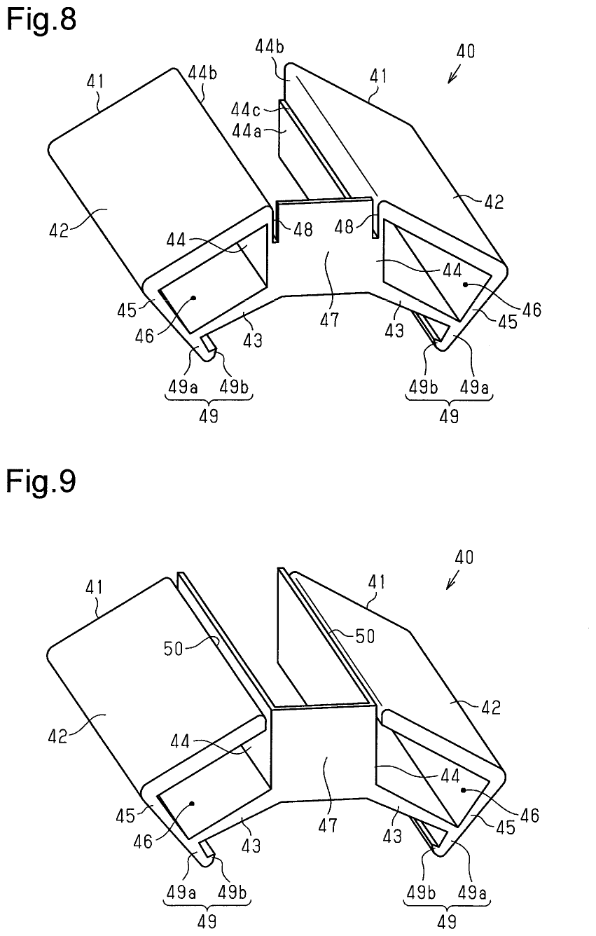

As shown in FIG. 8, the first support wall 44 may be connected to the coil contact wall 42 so that the coil contact wall 42 is continuous with the first support wall 44. In this case, the wall 41 may be hollow. In this configuration, the connecting passage 46, which is defined by the coil contact wall 42, the flange contact wall 43, the first support wall 44, and the second support wall 45, is a closed space excluding the openings at opposite ends. Thus, for example, the windings 34a in the slot 37 will not enter the connecting passage 46. This allows, for example, the neutral point of a coil 34 drawn from the coil end 34e to be inserted into the connecting passage 46 or a thermistor for measuring the temperature of the coils 34 to be inserted into the connecting passage 46. The connecting passage 46 may be effectively used as the space for a neutral point or a thermistor. Moreover, when inserting the neutral point into the connecting passage 46, the windings 34a located in the slot 37 will not enter the connecting passage 46. Thus, the neutral point may be inserted into the connecting passage 46 without being coated with an insulation tube. This simplifies the configuration. In this case, the walls 41 that are adjacent to each other in each slot 37 may be spaced apart from each other in the circumferential direction. In addition, when the walls 41 are hollow, the weight of the plastic members 40 is reduced as compared to when the walls 41 are not hollow.

As shown in FIG. 9, the plastic member 40 may include cutaway portions 50, or slits, into which the slot insulation sheets 39 are partially inserted. Each cutaway portion 50 is located between the radially outer end (end opposite to the flange contact wall 43) of the first support wall 44 and the end of the coil contact wall 42 located toward the first support wall 44. The cutaway portion 50 extends along the axis (in the longitudinal direction of the first support wall 44 and the longitudinal direction of the coil contact wall 42). The length of the cutaway portion 50 in the longitudinal direction is the same as the length of the first support wall 44 in the longitudinal direction and the length of the coil contact wall 42 in the longitudinal direction. The opposite ends of the slot insulation sheet 39 in the transverse direction extend through the cutaway portions 50 and are disposed in the connecting passages 46. The insulation distance between the coils 34 and the stator core 33 is increased by the portions of the slot insulation sheets 39 inserted into the cutaway portions 50 of the plastic members 40. Thus, the reliability of insulation between the coils 34 and the stator core 33 is improved.

As viewed in the axial direction of the rotation shaft 24, the first bearing holder 20 and a portion of the second bearing holder 22 may be partially located at a radially outer side or a radially inner side of the walls 41. That is, each of the first bearing holder 20 and the second bearing holder 22 may be at least partially opposed to the walls 41 and disposed at a radially inner side of the coil ends 34e.

The shape of the plastic member 40 may be changed. For example, the plastic member 40 may include the contact portion 47 and one wall 41 inserted into a slot 37.

The plastic member 40 does not have to include the contact portion 47. For example, the plastic member 40 may include one wall 41 and one hook 49 or may only include one wall 41.

The plastic member 40 does not have to include the hooks 49.

The slot insulation sheet 39 does not have to be partially disposed between the first support wall 44 and the tooth 36.

The centrifugal compressor 10 does not have to include the slot insulation sheets 39. In this case, the plastic member 40 may include an insulation portion extending along the side surface (surface defining slot 37) of the stator core 33.

The length of the coil contact wall 42, the flange contact wall 43, the first support wall 44, and the second support wall 45 of the plastic member 40 in the longitudinal direction may be the same as the length of the stator core 33 along the axis. The length of the coil contact wall 42, the flange contact wall 43, the first support wall 44, and the second support wall 45 of the plastic member 40 in the longitudinal direction may be slightly greater than the length of the stator core 33 along the axis. In this case, the centrifugal compressor 10 includes the first plastic members 40, which are inserted into the stator core 33 from the first end along the axis of the stator core 33, but does not include the second plastic members 40, which are inserted from the opposite side.

When the plastic members 40 are inserted from the two end surfaces 33a of the stator core 33, two of the plastic members 40 located next to each other along the axis of the stator core 33 are opposed to each other at an axial central position. In this case, the two plastic members 40 do not have to reach the central position and may be spaced apart from each other.

The wall 41 may have another shape and may be, for example, cylindrical. That is, the wall 41 extending along the axis may be disposed between the coil 34 and the flange 36f in the slot 37.

The windings 34a of the coils 34 may be wound on the teeth 36 by distributed winding.

The bearings are not limited to the first air bearing 21 and the second air bearing 23 and may be, for example, a rolling bearing or a sliding bearing.

The centrifugal compressor 10, for example, does not have to include the second impeller 26. Air may be compressed by the first impeller 25 and supplied to the fuel cell.

The motor-driven compressor is not limited to the centrifugal compressor 10 and may be, for example, a scroll motor-driven compressor.

The fluid compressed by the compression portion is not limited to air and may be, for example, a refrigerant gas.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A motor-driven compressor, comprising:
a compression portion configured to use rotation of a rotation shaft to compress a fluid;
an electric motor configured to rotate the rotation shaft, the electric motor including a tubular stator extending along an axis of the rotation shaft and a rotor disposed at an inner side of the stator in a radial direction; and
a housing accommodating the electric motor and including a tubular bearing holder that holds a bearing; wherein
the rotation shaft is rotationally supported by the bearing in the housing,
the stator includes a tubular stator core and coils,
the stator core includes teeth extending in the radial direction and slots defined between circumferentially adjacent ones of the teeth,
the coils are wound through the slots on the teeth,
the coils include a coil end projecting beyond at least one end surface of the stator core in an axial direction,
the motor-driven compressor further comprises plastic members, each of the plastic members including a wall extending along the axis and a connecting passage surrounded by the wall and extending along the axis,
each of the teeth includes a proximal end, which is an outer end in the radial direction, and a distal end including a flange,
the wall of each of the plastic members is disposed in a corresponding one of the slots between the coil and the flange,
the connecting passage has opposite ends in the axial direction, each of the opposite ends including an opening so that two spaces defined by the stator core in the housing are connected to each other through the connecting passage, and
the bearing holder is at least partially opposed to one of the openings of the connecting passage and disposed at an inner side of the coil end in the radial direction.

2. The motor-driven compressor according to claim 1, wherein each of the plastic members includes a contact portion that is in contact with the end surface of the stator core.

3. The motor-driven compressor according to claim 2, wherein
the wall is a first wall,
each of the plastic members includes the first wall, which is inserted into one of two adjacent ones of the slots located at opposite sides of one of the teeth, and a second wall inserted into the other slot, and
the first wall and the second wall are connected by the contact portion.

4. The motor-driven compressor according to claim 1, wherein
the flange includes an opposing surface opposed to the rotor, and
each of the plastic members includes a hook that engages the opposing surface.

5. The motor-driven compressor according to claim 1, further comprising a slot insulation sheet inserted into each of the slots and disposed between the stator core and the coils,
wherein each of the plastic members includes a cutaway portion into which the slot insulation sheet is partially inserted.

6. The motor-driven compressor according to claim 1, wherein
two of the plastic members are disposed to be adjacent to each other in one of the slots, and
the two of the plastic members are configured to elastically deform so that when the walls of the two of the plastic members are separated from each other, the slot is open toward the rotor, and so that when the walls of the two of the plastic members are in contact with each other, the opening of the slot toward the rotor is closed.
